(19) United States
(12) Patent Application Publication
(10) Pub. No.: US 2013/0143786 A1
(43) Pub. Date: Jun. 6, 2013

(54) ACTIVATED PEROXIDE CLEANING COMPOSITIONS

(71) Applicants: Shui-Ping Zhu, Berwyn, PA (US); Michael B. Abrams, Bala Cynwyd, PA (US); Xiawei Zhang, West Chester, PA (US); Xue Wang, Wayne, PA (US)

(72) Inventors: Shui-Ping Zhu, Berwyn, PA (US); Michael B. Abrams, Bala Cynwyd, PA (US); Xiawei Zhang, West Chester, PA (US); Xue Wang, Wayne, PA (US)

(73) Assignee: Arkema Inc., King of Prussia, PA (US)

(21) Appl. No.: 13/697,813

(22) PCT Filed: May 18, 2011
(86) PCT No.: PCT/US11/36914

§ 371 Date: Dec. 17, 2012

Related U.S. Application Data
(60) Provisional application No. 61/346,670, filed on May 20, 2010.

(51) Int. Cl. C11D 3/39

(52) U.S. Cl. CPC C11D 3/392
USPC 510/372; 510/376

(57) ABSTRACT

The present invention is directed towards cleaning composition and/or formulations of commercial cleaning products containing beneficial metallocarbene activators for peroxygen species. The cleaning compositions and/or formulations include a bleaching component comprising a peroxy compound and one or more activators present in an effective amount to activate the peroxy compound to accomplish bleaching or cleaning or oxidation. The activator is a metallocarbene of the general structure (XX′C)yMLn′ where M represents a metal center, C represents the carbene carbon bound to the metal center, X and X′ may be the same or different and may furthermore be part of a cyclic structure, Ln′ represents one or more other ligands which may or may not include one or more metal centers, and where y greater than equal to I.

### FIELD OF THE INVENTION

This present invention relates to peroxy bleach containing cleaning formulations containing metallocarbene complexes which activate the bleaches in the cleaning formulations. The peroxy compounds can include hydrogen peroxide or a hydrogen peroxide adduct or hydrogen peroxide generators or peracids or peracid generators. The present invention also relates to bleach containing cleaning compositions which contain metallocarbene activators for the peroxy compounds.

### BACKGROUND OF THE INVENTION

The efficacy of cleaning products is highly dependent on the formulation ingredients employed and the quantities in which they are used. Metallocarbene complexes have been found to activate peroxygen species such as hydrogen peroxide. The formulation ingredients and compositions suitable for use with metallocarbene activators and peroxygen species, useful cleaning formulations and products that incorporate metallocarbene activators and peroxygen compounds or precursors are the focus of the present invention.

Cleaning compositions that contain hydrogen peroxide are used for a wide variety of applications. Materials that react beneficially with the hydrogen peroxide are often included in peroxide containing cleaning compositions. For laundry detergent formulations, for example, substances that react with hydrogen peroxide to provide improved stain bleaching (versus peroxide alone or versus alternatives) are highly desirable. Cleaning formulations that contain hydrogen peroxide alone do not provide sufficient bleaching on all stains of interest and often do not provide sufficient stain bleaching at low temperatures. Current cleaning compositions which contain organic activators and hydrogen peroxide, such as peracid generators currently used for solid laundry detergents, typically operate stoichiometrically, providing economic challenges to practical implementation. It is known that many transition metal ions catalyze the decomposition of H₂O₂ and H₂O₂-liberating per-compounds, such as sodium perborate. It has also been suggested that transition metal salts together with a coordinating or chelating agent can be used in cleaning compositions to activate peroxide compounds so as to make them usable for satisfactory bleaching at lower temperatures or to provide enhanced bleaching performance at a given temperature. Current commercial metal-based activators suffer from deficiencies in one or more of the following areas: poor bleaching (oxidative) activity, poor fabric safety, poor solubility, prohibitively expensive economics, poor environmental fate profiles. Cleaning compositions which more effectively use hydrogen peroxide (whose sole degradation products are water and oxygen) could reduce the use of potentially harmful chlorine-based bleaches e.g. sodium hypochlorite for cleaning, or chlorine dioxide for pulp and paper. Iron (Fe), manganese (Mn), cobalt (Co), and copper (Cu) are relatively inexpensive metals. Cleaning compositions having a hydrogen peroxide activation catalyst employing any of these metals can provide significant economic and health/environment/safety advantages compared to current existing alternatives. Cleaning compositions containing peroxide activators based on other metals are also of interest.

### SUMMARY OF THE INVENTION

This present invention is directed towards useful formulations of ingredients and composition ranges for a variety of commercially relevant cleaning products containing metallocarbene activators for peroxygen species. The metallocarbene activators may impart bleaching or cleaning or stain removal or whiteness maintenance or anti-greying or dye transfer inhibition or disinfection or sanitization or antimicrobial or odor removal or reduced fabric damage or reduced pinholing or energy efficiency benefits relative to formulations that do not contain the metallocarbene activators or to formulations that contain activators not based on metal-carbene catalysts.

The efficacy of cleaning products is highly dependent on the formulation ingredients employed and the quantities in which they are used. Metallocarbene complexes have been found to activate peroxygen species such as hydrogen peroxide. The present invention is directed toward formulation ingredients and compositions suitable for use with metallocarbene activators and peroxygen species, and useful cleaning formulations and products that incorporate metallocarbene activators and peroxygen compounds or precursors.

The compositions and/or formulations of the present invention can include: laundry detergent (powdered or solid/tablet or liquid), fabric softener, laundry prespotter (spray or gel or pen), auxiliary bleach (solid or liquid or paste), hand dish detergent, automatic dishwasher detergent (powdered or gel or tablet or paste or suspension), carpet prespotter, carpet cleaner, hard surface cleaner (spray or concentrated/dilutable), toilet bowl cleaner, hand detergent, general basin/tub/tile foam cleaner, abrasive surface cleaner, and activator-containing laundry sheet formulations incorporating metallocarbene complexes obtained by combining appropriate bleaching agents, activators, primary surfactants, co-surfactants, humectants, enzymes, enzyme stabilizing agents, thickeners and dispersants, fluorescent dyes, coupling agents, organic solvents, builders, abrasives, chelating agents, acids, fragrances, dyes, colorants, bleach boosters, brighteners, organic polymers, dye transfer inhibiting agents, chelating agents, catalyst/activator/booster carriers, preformed peracids, hydrotropes, antimicrobial agents, antibacterial agents, perfumes, suds suppressors, anti-corrosion agents, tarnish inhibitors, fabric softeners, carriers, processing aids, solvents, pigments, and water in appropriate quantities.

Tables 1-4 provide exemplary formulations for various cleaning compositions incorporating metallocarbene activators in accordance with the present invention, providing ranges (w/w %) of exemplary ingredients in total formulations, based on 100% purity of exemplary ingredient.

TABLE 1

| Product form | | Solid | | |
|---|---|---|---|---|
| 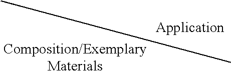 | | Laundry Detergent | Foam Cleaner | Laundry Sheet |
| Bleaching agents | Sodium Percarbonate | 1~30 | 1~30 | |
| | Sodium Perborate | | | |
| | H2O2/peracetic acid | | | 0.05~5 |
| | Other | | | |
| Activators | MCat4 | 0.000001~5 | 0.000001~5 | |
| | MCat6 | | | |
| | MCat7 | | | 0.000001~40 |
| Surfactants | Anionic | 1~30 | 0.1~10 | 0.1~15 |
| | Nonionic | 1~20 | 0.1~10 | 0.1~15 |
| | Amphoteric | | | |
| | Cationic | | | |
| Co-surfactants | Fatty alcohol | | | |
| | Fatty acid | | | |
| Humectants | Glycerine | | | |
| | Other | | | |
| Enzymes | Protease | 0.01~1 | | |
| | Amylase | 0.01~1 | | |
| | Lipase | 0.01~1 | | |
| | Mannase | 0.01~1 | | |
| Thickeners & dispersants | | 0.1~2 | | |
| Fluorescent dye | Tinopal CBS-X | 0~0.5 | | |
| Coupling agents | Xylene sulfonate | | | |
| | Cumene sulfonate | | | |
| | Toluene sulfonate | | | |
| | Other | | | |
| Polar organic solvents | Ethanol | | | |
| | Ethylene glycol | | | |
| | other | | | |
| Builders | Sodium carbonate | 1~30 | 1~30 | |
| | Sodium silicate | 1~30 | | |
| | Sodium sulfate | 1~20 | 1~50 | |
| Abrasives | Silica/other | | | |
| Chelating agents | Citric acid | | | |
| | Iminodisuccinate | | | |
| | Amine phosphonate | | | |
| Acids | Sulfuric acid | | | |
| | Methyl sulfonic acid | | | |
| | Sulfamic acid | | 1~30 | |
| Water & minors | (e.g. fragrance, | balance | balance | balance |
| | colorants, dyes, | | | |
| | enzyme stabilizing | | | |
| | agents) | | | |

| | | | |
|---|---|---|---|
| pH (1% water solution) | 8~13 | 8~13 | 5~8 |

Mcat4 = Tris[2-(3-tert-butyl-imidazol-2-ylidene-1-yl)ethyl]amine Manganese Bis(acetate)
Mcat6 = Tris(1-methyl-3-octylimidizol-2-ylidene) Manganese Bis(acetate)
Mcat7 = Bis{1-[(pyrid-2-yl)methyl]-3-tert-butylimidazol-2-ylidene} Iron Bis(tetrafluoroborate)

TABLE 2

| Product form | | Liquid (Transparent or Emulsion) | | | |
|---|---|---|---|---|---|
| 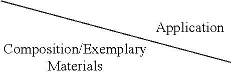 | | Laundry Detergent | Laundry Bleach | Laundry Prespot | Laundry Softener |
| Bleaching agents | Sodium Percarbonate | | | | |
| | Sodium Perborate | | | | |
| | H2O2/peracetic acid | 1~8 | 1~8 | 0.1~5 | 1~8 |
| | Other | | | | |
| Activators | MCat4 | | | 0.000001~90 | 0.000001~5 |
| | MCat6 | 0.000001~5 | 0.000001~10 | | |
| | MCat7 | | | | |
| Surfactants | Anionic | 1~40 | 0~10 | 0.05~8 | |
| | Nonionic | 1~40 | 0~10 | 0.05~8 | 0~2 |
| | Amphoteric | 0~10 | 0~10 | 0.05~8 | |
| | Cationic | | | | 2~30 |
| Co-surfactants | Fatty alcohol | | | | |
| | Fatty acid | | | | |
| Humectants | Glycerine | | | | |
| | Other | | | | |
| Enzymes | Protease | | | | |
| | Amylase | | | | |
| | Lipase | | | | |
| | Mannase | | | | |
| Thickeners & dispersants | | 0~2 | 0~2 | | |
| Fluorescent dye | Tinopal CBS-X | 0~0.5 | 0~0.5 | | |
| Coupling agents | Xylene sulfonate | 0~5 | | | |
| | Cumene sulfonate | | | | |
| | Toluene sulfonate | | | | |
| | Other | | | | |
| Polar organic solvents | Ethanol | 0.1~5 | | | |
| | Ethylene glycol | | | | |
| | other | | 1~5 | | |
| Builders | Sodium carbonate | | | | |
| | Sodium silicate | | | | |
| | Sodium sulfate | | | | 0.01~2 |
| Abrasives | Silica/other | | | | |
| Chelating agents | Citric acid | | | 0~3 | |
| | Iminodisuccinate | 0~3 | 0~3 | | |
| | Amine phosphonate | | | | |
| Acids | Sulfuric acid | | | | |
| | Methyl sulfonic acid | | | | |
| | Sulfamic acid | | | | |
| Water & minors | (e.g. fragrance, | balance | balance | balance | balance |
| | colorants, dyes, | | | | |
| | enzyme stabilizing | | | | |
| | agents) | | | | |

| | | | | |
|---|---|---|---|---|
| pH (1% water solution) | 7~10 | 3~10 | 8~10 | 3~10 |

Mcat4 = Tris[2-(3-tert-butyl-imidazol-2-ylidene-1-yl)ethyl]amine Manganese Bis(acetate)
Mcat6 = Tris(1-methyl-3-octylimidizol-2-ylidene) Manganese Bis(acetate)
Mcat7 = Bis{1-[(pyrid-2-yl)methyl]-3-tert-butylimidazol-2-ylidene} Iron Bis(tetrafluoroborate)

TABLE 3

| Product form | | Liquid (Transparent or Emulsion) | | | | |
|---|---|---|---|---|---|---|
| 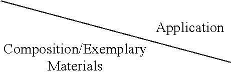 | | Hard Surface Cleaner | Hand Dish Soap | Hand Soap | Carpet Cleaner | Toilet Bowl Cleaner |
| Bleaching agents | Sodium Percarbonate | | | | | |
| | Sodium Perborate | | | | | |
| | H2O2/peracetic acid | 0.2~8 | 1~8 | 0.1~5 | 1~8 | 1~8 |
| | Other | | | | | |
| Activators | MCat4 | 0.000001~5 | | 0.000001~5 | | 0.000001~10 |
| | MCat6 | | 0.000001~5 | | | |
| | MCat7 | | | | 0.000001~5 | |
| Surfactants | Anionic | 0~10 | 2~30 | 2~30 | 0~5 | 0~10 |
| | Nonionic | 0.1~10 | 2~10 | 2~10 | 0~5 | 0~10 |
| | Amphoteric | 0~5 | 0~5 | 1~5 | 0.01~5 | |
| | Cationic | 0~5 | | | | |
| Co-surfactants | Fatty alcohol | | | 3 | | |
| | Fatty acid | | | 2 | | |
| Humectants | Glycerine | | | 5 | | |
| | Other | | | 2 | | |
| Enzymes | Protease | | | | | |
| | Amylase | | | | | |
| | Lipase | | | | | |
| | Mannase | | | | | |
| Thickeners & dispersants | | 0~2 | 0~5 | | | |
| Fluorescent dye | Tinopal CBS-X | | | | | |
| Coupling agents | Xylene sulfonate | | 0~5 | | | |
| | Cumene sulfonate | | | | | |
| | Toluene sulfonate | | | | | |
| | Other | | | | | |
| Polar organic solvents | Ethanol | 0~5 | 0~5 | | | |
| | Ethylene glycol | | | | | |
| | other | | | 0.1~15 | | |
| Builders | Sodium carbonate | | | | | |
| | Sodium silicate | | | | | |
| | Sodium sulfate | | | | | |
| Abrasives | Silica/other | | | | | |
| Chelating agents | Citric acid | 0~3 | | | | |
| | Iminodisuccinate | | 0~5 | | | |
| | Amine phosphonate | | | | | |
| Acids | Sulfuric acid | | | | | 0~10 |
| | Methyl sulfonic acid | | | | | |
| | Sulfamic acid | | | | | |
| Water & minors | (e.g. fragrance, | balance | balance | balance | balance | balance |
| | colorants, dyes, | | | | | |
| | enzyme stabilizing | | | | | |
| | agents) | | | | | |

| | | | | | |
|---|---|---|---|---|---|
| pH (1% water solution) | 3~10 | 3~10 | 5~8 | 5~8 | very acidic |

Mcat4 = Tris[2-(3-tert-butyl-imidazol-2-ylidene-1-yl)ethyl]amine Manganese Bis(acetate)
Mcat6 = Tris(1-methyl-3-octylimidizol-2-ylidene) Manganese Bis(acetate)
Mcat7 = Bis{1-[(pyrid-2-yl)methyl]-3-tert-butylimidazol-2-ylidene} Iron Bis(tetrafluoroborate)

TABLE 4

| Product form | | Liquid (Gel) | |
|---|---|---|---|
| 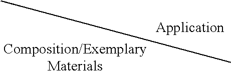 | | Abrasive Cleaner | Auto Dish Gel |
| Bleaching agents | Sodium Percarbonate | | |
| | Sodium Perborate | | |
| | H2O2/peracetic acid | 0.2~8 | 1~8 |
| | Other | | |
| Activators | MCat4 | | 0.000001~5 |
| | MCat6 | | |
| | MCat7 | 0.000001~5 | |
| Surfactants | Anionic | 0.1~10 | |
| | Nonionic | 0.1~10 | 0~10 |
| | Amphoteric | | |
| | Cationic | | |
| Co-surfactants | Fatty alcohol | | |
| | Fatty acid | | |
| Humectants | Glycerine | | |
| | Other | | |
| Enzymes | Protease | | |
| | Amylase | | |
| | Lipase | | |
| | Mannase | | |
| Thickeners & dispersants | | 0.01~5 | 0~5 |
| Fluorescent dye | Tinopal CBS-X | | |
| Coupling agents | Xylene sulfonate | | |
| | Cumene sulfonate | | |
| | Toluene sulfonate | | |
| | Other | | |
| Polar organic solvents | Ethanol | | |
| | Ethylene glycol | | |
| | other | | |
| Builders | Sodium carbonate | | |
| | Sodium silicate | | |
| | Sodium sulfate | 0~30 | 0~30 |
| Abrasives | Silica/other | 1~30 | |
| Chelating agents | Citric acid | | |
| | Iminodisuccinate | | |
| | Amine phosphonate | | 0~10 |
| Acids | Sulfuric acid | | |
| | Methyl sulfonic acid | | |
| | Sulfamic acid | | |
| Water & minors | (e.g. fragrance, | balance | balance |
| | colorants, dyes, | | |
| | enzyme stabilizing | | |
| | agents) | | |

| | | |
|---|---|---|
| pH (1% water solution) | 2~10 | 3~10 |

Mcat4 = Tris[2-(3-tert-butyl-imidazol-2-ylidene-1-yl)ethyl]amine Manganese Bis(acetate)
Mcat6 = Tris(1-methyl-3-octylimidizol-2-ylidene) Manganese Bis(acetate)
Mcat7 = Bis{1-[(pyrid-2-yl)methyl]-3-tert-butylimidazol-2-ylidene} Iron Bis(tetrafluoroborate)

Additional cleaning formulations are within the scope of this invention. For example, although no solid or powdered or tablet autodish (automatic dishwashing) formulations are included in the tables, these types of formulations are within the scope of the invention. An “activator tablet” or “activator stick”, which is composed largely of activator and a binding agent and possibly a peroxygen source, is also within the scope of this invention. Also within the scope of this invention are “activator sheets” in which activator is supported or adsorbed onto on a woven- or nonwoven fabric, which may or may not contain peroxygen source and/or surfactant.

Tables 1-4 list only selected (representative) examples of each type of ingredient, whereas other examples of each ingredient type are within the scope of this invention. For example, although three activators are listed in Tables 1-4, the invention encompasses all metal-carbene type activators, including all those described in WO2009140259.

In addition, although only one activator per formulation is typically listed in Tables 1-4, cleaning product formulations may also include a mixture of two or more activators. When more than one activator is included in a single formulation, the activators need not be all metal-carbene-type activators; one or more of the other activators may be organic activators (including but not limited to N,N,N′,N′-tetraacetylethylenediamine (TAED) or nonanoyloxybenzenesulfonate sodium (NOBS) or iminium-containing species including but not limited to sulphuric acid mono-[2-(3,4-dihydro-isoquinolin-2-yl)-1-(2-butyl-octyloxymethyl)-ethyl]ester and sulphuric acid mono-[2-(3,4-dihydro-isoquinolin-2-yl)-1-(2-ethylhexyloxymethyl)-ethyl]ester, and acetonitrile derivatives including but not limited to N-methylmorpholinium acetonitrile methylsulfate and N-methylmorpholinium acetonitrile hydrogensulfate) or metal catalysts including but not limited to tri-mu-oxo-bis[(1,4,7-trimethyl-1,4,7-triazacyclononane)manganese]bis(acetate) or tri-mu-oxo-bis[(1,4,7-trimethyl-1,4,7-triazacyclononane)manganese]bis(hexafluorophosphate), [5,12-diethyl-1,5,8,12,-tetraaza-bicyclo[6.6.2]hexadecane]manganese dichloride, and mixtures thereof.

The hydrogen peroxide/PAA (peracetic acid) listed in the table denotes that either hydrogen peroxide or peracetic acid may be included in the formulation. Also within the scope of the present invention are mixtures of bleaching agents; for example, a single formulation may contain both hydrogen peroxide and peracetic acid.

Ingredients not explicitly listed in Tables 1-4 may also be included in the formulations. For example, although not specifically included in Tables 1-4, this invention encompasses formulations also including ingredients such as bleach boosters, brighteners, organic polymers, dye transfer inhibiting agents, chelating agents, catalyst/activator/booster carriers, preformed peracids, hydrotropes, antimicrobial agents, antibacterial agents, perfumes, suds suppressors, anti-corrosion agents, tarnish inhibitors, fabric softeners, carriers, processing aids, solvents, pigments, and mixtures thereof.

The metallocarbene complex activators which activate bleaches employing peroxy compounds in the formulations of the present invention are of the general structure 1:

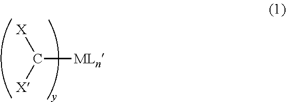

where M represents a metal center, C represents the carbene carbon bound to the metal center, X and X′ may be the same or different (and may furthermore be part of a cyclic structure), and are preferably selected from the group C, N, O, Si, P, or S, each of which may be substituted with hydrogen and or C1-C20 linear or branched hydrocarbons which may furthermore contain heteroatom substituents and which may form or be part of a cyclic structure. Lₙ′ represents one or more species (which independently represent a coordinating or bridging ligand or non-coordinating species, and may or may not include one or more metal centers), preferably selected from the group H₂O, ROH, ROR, NR₃, PR₃, RCN, HO⁻, HS⁻, HOO⁻, RO⁻, RCOO⁻, F₃CSO₃⁻, BPh₄⁻, PF₆⁻, ClO₄⁻, OCN⁻, SCN⁻, NR₂⁻, N₃⁻, CN⁻, F⁻, Cl⁻, Br⁻, I⁻, H⁻, R⁻, O₂⁻, O²⁻, NO₃⁻, NO₂⁻, SO₄²⁻, RSO₃⁻, SO₃²⁻, RBO₂²⁻, PO₄³⁻, organic phosphates, organic phosphonates, organic sulfates, organic sulfonates, and aromatic N donors such as pyridines, bipyridines, terpyridines, pyrazines, pyrazoles, imidazoles, benzimidazoles, pyrimidines, triazoles, and thiazoles, and can include one or more additional carbene ligands, and where y≧1 and preferably from 1 to 4. R can be the same or different and be hydrogen, alkyl, aryl, substituted alkyl, substituted aryl, and mixtures thereof. The use of Fe, Mn, and Cu as the metal (M) are preferred, however metallocarbene catalysts based on Co, Mo, W, V, and Ti, and other suitable metals are within the scope of the present invention.

There are many potential structural variations on the above carbene ligand framework, including, but not limited to:

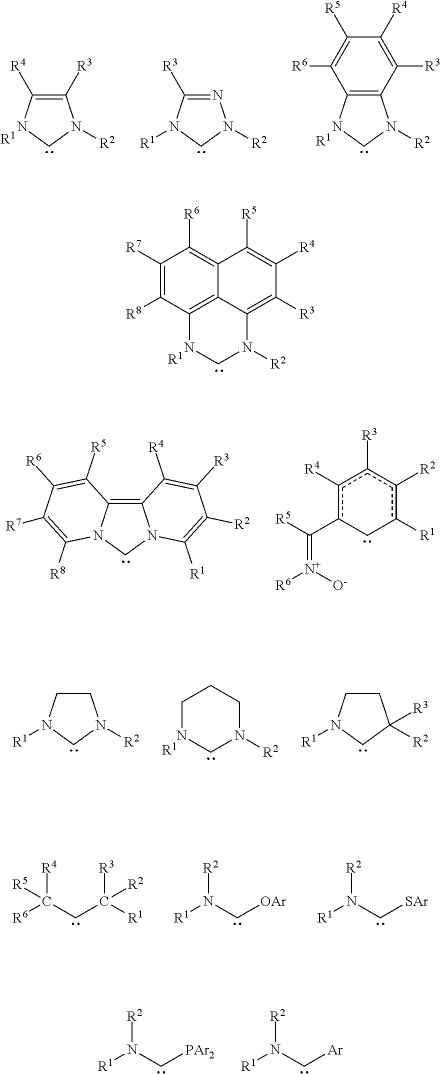

The carbene ligand substituents R¹-R¹⁰ may be the same or different. They may be hydrogen or C1-C20 linear or branched hydrocarbons, including but not limited to methyl, chloromethyl, ethyl, propyl, isopropyl, tert-butyl, sec-butyl, n-butyl, pentyl, n-hexyl, cyclohexyl, heptyl, octyl, nonyl, lauryl, adamantyl, benzyl, phenyl, substituted phenyls such as chlorophenyl, dichlorophenyl, methylphenyl, nitrophenyl, aminophenyl, dimethylphenyl, pentafluorophenyl, methoxyphenyl, trifluoromethylphenyl, bis(trifluoromethyl)phenyl, 2,4,6-trimethylphenyl, 2,6-diisopropylphenyl groups and may furthermore have one or more heteroatom containing group including but not limited to halides, amines, amides, pryidyls, ethers, aldehydes, ketones, phosphines, and sulfonates. Ar denotes an aryl group, which may be substituted with one or more hydrogen or C1-C20 linear or branched hydrocarbons which may contain heteroatom substituents, including but not limited to methyl, ethyl, propyl, isopropyl, tert-butyl, sec-butyl, n-butyl, pentyl, n-hexyl, cyclohexyl, heptyl, octyl, nonyl, lauryl, adamantyl, benzyl, phenyl, substituted phenyls such as chlorophenyl, dichlorophenyl, methylphenyl, dimethylphenyl, pentafluorophenyl, methoxyphenyl, nitrophenyl, aminophenyl, trifluoromethylphenyl, bis(trifluoromethyl)phenyl, 2,4,6-trimethylphenyl, 2,6-diisopropylphenyl groups, and may furthermore have one or more heteroatom containing groups including but not limited to halides, amines, amides, pryidyls, ethers, aldehydes, ketones, phosphines, and sulfonates. The carbenes can incorporate zwitterions such as the nitrone shown. The metallocarbenes may be chiral, either by incorporation of one or more chiral substituents on the carbene ligand, by the arrangement of various substituents on the carbene ligand, and/or by arrangement of the various groups around the metal center.

The cleaning formulations of the present invention encompasses activators with one or more carbene groups. In activators with more than one carbene groups, the individual carbene groups may either be the same or different. Exemplary substitutions of the carbene ligand or ancillary ligand arrays are provided herein below.

Examples of polydentate carbene ligands include not only bis(carbene) ligands, tris(carbene) ligands, and higher poly(carbene) ligands, but also carbene ligands with one or more non-carbene groups capable of coordinating to a metal center, including, but not limited to, the structures shown and described below.

There are many potential variations on the above carbene ligand framework; the following description will focus on the framework of structure 1, although any of the metallocarbenes or variations thereof described herein are envisioned by the present invention.

Preferred structures include:

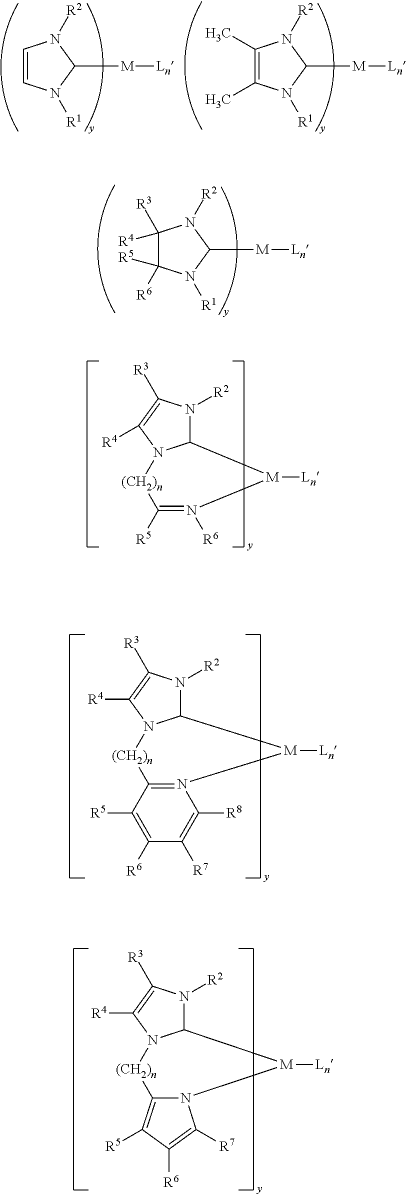

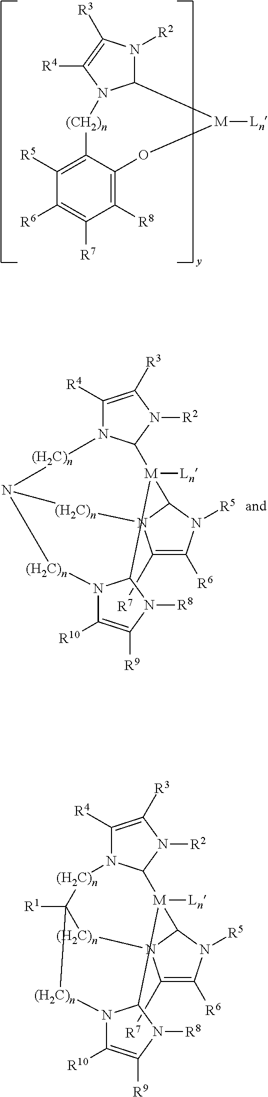

and versions where the carbene heterocycle is saturated; y=1-4; n=0-5; M, Lₙ′, and R¹-R¹⁰ as defined above.

Within the scope of this invention are metallocarbene activators that are pre-formed, and metallocarbene activators that are generated in-situ by combination of appropriate formulation ingredients.

Although hydrogen peroxide is a preferred oxidant in the cleaning formulations of the present invention, the activators invention could alternately, or in addition, provide activation in conjunction with other peroxides or peroxide precursors, for example alkylhydroperoxides, dialkylperoxides, peracids, inorganic perhydrate salts, including alkali metal salts such as sodium salts of perborate (usually mono- or tetrahydrate), percarbonate, persulfate, perphosphate, persilicate salts, and/or dioxygen. Also within the scope of this invention are cleaning compositions which include bleaching with compositions of the activators described and sodium percarbonate, sodium perborate, or other materials that generate peroxides or peracids.

As used herein detergent compositions include articles and cleaning and/or treatment compositions. As used herein, the term “cleaning and/or treatment composition” includes, unless otherwise indicated, tablet, granular or powder-form all purpose or “heavy-duty” washing agents, especially laundry detergents; liquid, gel or paste-form, or supported or adsorbed on woven or non-woven fibers, all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid, and rinse-aid types for household and institutional use. The compositions can also be in containers with multiple reservoirs or in unit dose packages, including those known in the art and those that are water soluble, water insoluble, and/or water permeable.

Suitable formulation ingredients include, but are not limited to bleaching agents, activators, surfactants, humectants, enzymes, thickeners, dispersants, fluorescent dyes, coupling agents, polar organic solvents, builders, abrasives, chelating agents, acids, fragrances, colorants, dyes, enzyme stabilizing agents, bleach boosters, brighteners, organic polymers, dye transfer inhibiting agents, chelating agents, catalyst/activator/booster carriers, preformed peracids, hydrotropes, antimicrobial agents, antibacterial agents, perfumes, suds suppressors, anti-corrosion agents, tarnish inhibitors, fabric softeners, carriers, processing aids, solvents, pigments, water, and mixtures thereof.

Examples of suitable bleaching agents include:

1) Hydrogen peroxide, and sources of hydrogen peroxide, for example, inorganic perhydrate salts, including alkali metal salts such as sodium salts of perborate (usually mono- or tetrahydrate), percarbonate, persulfate, perphosphate, persilicate salts and mixtures thereof, atmospheric oxygen, organic peroxides, organic perhydroxides, and pre-formed or in-situ-generated peracids.

2) One or more bleach activators of the current invention of the general structure 1:

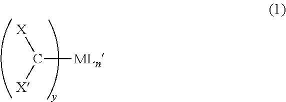

where M represents a metal center selected from Fe, Os, Mn, Re, Cu, Ag, Au, Co, Cr, Mo, W, Ru, Sc, Y, La, Ti, Zr, Hf, V, Nb, Ta, Ni, Pd, Pt, and Zn, C represents the carbene carbon bound to the metal center, X and X′ may be the same or different (and may furthermore be part of a cyclic structure), and are preferably selected from the group C, N, O, Si, P, or S, each of which may be substituted with hydrogen and or C1-C20 linear or branched hydrocarbons which may furthermore contain heteroatom substituents and which may form or be part of a cyclic structure. Lₙ′ represents one or more species (which independently represent a coordinating or bridging ligand or non-coordinating species, and may or may not include one or more metal centers), preferably selected from the group H₂O, ROH, ROR, NR₃, PR₃, RCN, HO⁻, HS⁻, HOO⁻, RO⁻, RCOO⁻, F₃CSO₃⁻, BF₄⁻, BPh₄⁻, PF₆⁻, ClO₄⁻, OCN⁻, SCN⁻, NR₂⁻, N₃⁻, CN⁻, F⁻, Cl⁻, Br⁻, I⁻, H⁻, R⁻, O₂⁻, O²⁻, NO₃⁻, NO₂⁻, SO₄²⁻, RSO₃⁻, SO₃²⁻, RBO₂²⁻, PO₄³⁻, organic phosphates, organic phosphonates, organic sulfates, organic sulfonates, and aromatic N donors such as pyridines, bipyridines, terpyridines, pyrazines, pyrazoles, imidazoles, benzimidazoles, pyrimidines, triazoles, and thiazoles, and can include one or more additional carbene ligands, and where y≧1 and preferably from 1 to 4. R can be the same or different and be hydrogen, alkyl, aryl, substituted alkyl, substituted aryl, and mixtures thereof. The use of Fe, Mn, and Cu as the metal (M) are preferred, however metallocarbene catalysts based on Co, Mo, W, V, and Ti, and other suitable metals are within the scope of the present invention.

3) One or more additional bleach activators or catalysts or boosters may include N,N,N′,N′-tetraacetylethylenediamine, nonanoyloxybenzene sulfonate, lauroyloxybenzene sulfonate, benzyloxybenzene sulfonate, tri-mu-oxo-bis[(1,4,7-trimethyl-1,4,7-triazacyclononane)manganese]bis(acetate), tri-mu-oxo-bis[(1,4,7-trimethyl-1,4,7-triazacyclononane)manganese]bis(hexafluorophosphate), [5,12-diethyl-1,5,8,12,-tetraaza-bicyclo[6.6.2]hexadecane]manganese dichloride, iminium-containing species including but not limited to sulphuric acid mono-[2-(3,4-dihydro-isoquinolin-2-yl)-1-(2-butyl-octyloxymethyl)-ethyl]ester and sulphuric acid mono-[2-(3,4-dihydro-isoquinolin-2-yl)-1-(2-ethylhexyloxymethyl)-ethyl]ester, and acetonitrile derivatives including but not limited to N-methylmorpholinium acetonitrile methylsulfate and N-methylmorpholinium acetonitrile hydrogensulfate, and mixtures thereof.

### EXAMPLES

The following examples set out exemplary processes for making and the results of testing of metallocarbene complexes in accordance with the present invention. These examples are not intended to be limiting. The procedures and materials used could be easily obtained or duplicated by a person of ordinary skill in the art without undue experimentation.

In the examples the following metallocarbene activators were tested:

| Activator | |
|---|---|
| Designation | Name |
| 1 | Tris[2-(3-methylimidazol-2-ylidene-1-yl)ethyl]amine |
| | Manganese Sulfate |
| 2 | Tris[2-(3-tert-butylimidazol-2-ylidene-1-yl)ethyl]amine |
| | Manganese Bis(acetate)- |
| 3 | Tris(1-butyl-3-methylimidazol-2-ylidene) Manganese |
| | Dichloride |
| 4 | Bis(1-[(pyrid-2-yl)methyl]-3-isopropylimidazol-2-ylidene) |
| | Iron Dichloride |
| 5 | Tris[2-(3-methylimidazol-2-ylidene-1-yl)ethyl]amine |
| | Manganese Bis(trifluoromethanesulfonate)- |
| 6 | Tris[2-(3-tert-butyl-imidazol-2-ylidene-1-yl)ethyl]amine |
| | Manganese Dichloride |
| 7 | Bis-mu-tert-butoxy-bis[(1-butyl-3-methylimidazol-2-ylidene) |
| | Manganese Acetate] |
| 8 | Bis(1-[(pyrid-2-yl)methyl]-3-tert-butylimidazol-2-ylidene) |
| | Iron-Bis(trifluromethanesulfonate) |

Activators 1-6 and 8 were synthesized according to published procedures [WO2009140259]. Activator 7 was generated by treatment of manganese(II) acetate with in-situ generated carbene ligand from 1-butyl-3-methylimidazolium chloride and potassium tert-butoxide.

In the examples, the following non-metallocarbene activators were tested as comparative materials:

| Activator | |
|---|---|
| Designation | Name |
| TAED | N,N,N′,N′-tetracetylethylenediamine [available from |
| | Alfa Aesar] |
| A350 | tri-mu-oxo-bis[(1,4,7-trimethyl-1,4,7-triazacyclononane) |
| | Manganese]bis(acetate), [3.5 wt % in aqueous solution with |
| | sodium acetate/acetic acid; available from Rahu Catalytics] |
| KB2 | Tinocat ® TRS KB2 [Granules containing N,N,N-tris[2- |
| | (salicylideneaminato)ethyl]amine-manganese; |
| | available from BASF] |

### Example 1

The relative reactivity of various potential catalytic activators with hydrogen peroxide was assessed using the following procedures: 10 mg of activator was charged to a 20-ml glass scintillation vial. Aqueous hydrogen peroxide (5 ml of 5% hydrogen peroxide solution) was charged to each vial, and the vials swirled gently to provide mixing. The extent of bubbling and gas evolution over approximately the first 10 minutes after hydrogen peroxide addition was assessed visually and categorized using the following scale (1-6), with lower numbers denoting greater reactivity: 1=very vigorous; 2=vigorous; 3=moderate; 4=small; 5=very slight; 6=none. Table 5 summarizes the results.

TABLE 5

| | | Reactivity |
|---|---|---|
| Example | Activator | (1-5) |
| 1 | 1 | 2 |
| 2 | 2 | 2 |
| 3 | 3 | 3 |
| 4 | 4 | 5 |
| 5 | 5 | 3 |
| 6 | 6 | 1 |
| 7 | TAED | 6 |
| 8 | A350 | 4 |
| 9 | KB2 | 3 |

The M-carbene-containing activators exhibited the highest reactivity with hydrogen peroxide. M-carbene activators 1, 2, and 6 all demonstrated higher reactivity than the three comparative activators (TAED, A350, and KB2). M-carbene activators 3 and 5 were more reactive than TAED and A350, and approximately equal in activity to KB2. Of the M-carbene activators tested, only Activator 4 demonstrated lower activity than the two Mn-containing comparative activators. TAED, which contains no metal, showed the lowest overall catalytic activity with hydrogen peroxide in this test.

### Example 2

### Cleaning Experiments

Tables 6 and 7 show the compositions of test formulations A-R, which are employed in Evaluations 1-96; unless otherwise noted, entries reflect the mass (mg) of the various ingredients used in the 1-L reactor beakers. Metal-containing activators were charged to provide in-wash metal concentrations of approximately 1.1×10⁻⁵ mol/L. The A350 entry denotes the mass of Mn-containing activator tri-mu-oxo-bis[(1,4,7-trimethyl-1,4,7-triazacyclononane)manganese]bis(acetate) in the overall A350 formulation charged to the Terg-O-Tometer beaker. As the specific concentration of Mn in the Tinocat® TRS KB2 formulation is not readily available, the KB2 was charged according to manufacturer recommendations (approximately 0.5-2.0%). The organic activator TAED was utilized at approximately 1.1×10⁻⁵ mol/L.

TABLE 6

| | Formulation | | | | | | | | |
|---|---|---|---|---|---|---|---|---|---|
| | A | B | C | D | E | F | G | H | I |
| Stepan Bio-Soft N25-7 | 120 | 120 | 120 | 120 | 120 | 120 | 120 | 120 | 120 |
| Stepan Bio-Soft S-101 | 80 | 80 | 80 | 80 | 80 | 80 | 80 | 80 | 80 |
| Sodium carbonate | 500 | 500 | 500 | 500 | 500 | 500 | 500 | 500 | 500 |
| Sodium sulfate | 168 | 168 | 168 | 168 | 168 | 168 | 168 | 168 | 168 |
| Sodium silicate | 120 | 120 | 120 | 120 | 120 | 120 | 120 | 120 | 120 |
| Carboxymethylcellulose | 10 | 10 | 10 | 10 | 10 | 10 | 10 | 10 | 10 |
| Tinopal CBS-X | 2 | 2 | 2 | 2 | 2 | 2 | 2 | 2 | 2 |
| Sodium percarbonate | 192 | 191 | 192 | 191 | 193 | 191 | 193 | 193 | 191 |
| Activator 1 | 6.2 | | | | | | | | |
| Activator 2 | | 7.5 | | | | | | | |
| Activator 3 | | | 6.5 | | | | | | |
| Activator 4 | | | | 6.1 | | | | | |
| Activator 7 | | | | | 5.0 | | | | |
| Activator 8 | | | | | | 7.2 | | | |
| TAED | | | | | | | 2.7 | | |
| A350* | | | | | | | | 3.5 | |
| KB2** | | | | | | | | | 5.6 |

*The A350 entry denotes the mass of Mn-containing activator tri-mu-oxo-bis[(1,4,7-trimethyl-1,4,7-triazacyclononane)manganese] bis(acetate) in the overall A350 formulation charged to the terg-o-tometer beaker.
**Tinocat ® TRS KB2 was charged according to manufacturer recommendations (approximately 0.5-2.0%).

TABLE 7

| | Formulation | | | | | | | | |
|---|---|---|---|---|---|---|---|---|---|
| | J | K | L | M | N | O | P | Q | R |
| Stepan Bio-Soft N25-7 | 120 | 120 | 120 | 120 | 120 | 120 | 120 | 120 | 120 |
| Huish methyl ester | 80 | 80 | 80 | 80 | 80 | 80 | 80 | 80 | 80 |
| sulfonate | | | | | | | | | |
| Sodium carbonate | 500 | 500 | 500 | 500 | 500 | 500 | 500 | 500 | 500 |
| Sodium sulfate | 168 | 168 | 168 | 168 | 168 | 168 | 168 | 168 | 168 |
| Sodium silicate | 120 | 120 | 120 | 120 | 120 | 120 | 120 | 120 | 120 |
| Carboxymethylcellulose | 10 | 10 | 10 | 10 | 10 | 10 | 10 | 10 | 10 |
| Tinopal CBS-X | 2 | 2 | 2 | 2 | 2 | 2 | 2 | 2 | 2 |
| Sodium percarbonate | 192 | 192 | 192 | 192 | 192 | 191 | 190 | 192 | 191 |
| Activator 1 | 6.2 | | | | | | | | |
| Activator 2 | | 7.3 | | | | | | | |
| Activator 3 | | | 6.5 | | | | | | |
| Activator 4 | | | | 5.9 | | | | | |
| Activator 7 | | | | | 4.9 | | | | |
| Activator 8 | | | | | | 7.1 | | | |
| TAED | | | | | | | 2.7 | | |
| A350* | | | | | | | | 3.5 | |
| KB2** | | | | | | | | | 5.6 |

*The A350 entry denotes the mass of Mn-containing activator tri-mu-oxo-bis[(1,4,7-trimethyl-1,4,7-triazacyclononane)manganese] bis(acetate) in the overall A350 formulation charged to the terg-o-tometer beaker.
**Tinocat ® TRS KB2 was charged according to manufacturer recommendations (approximately 0.5-2.0%).

The cleaning experiment procedure comprised adding 1 L of tap water to a 2-L stainless steel beaker, and placing the beaker in a temperature-regulated (30° C.) water bath (Terg-o-Tometer; Instrument Marketing Services, Inc., Fairfield, N.J.) with vertical impeller agitation. Detergent base (a premix of nonionic and anionic surfactants, sodium carbonate, sodium sulfate, sodium silicate, carboxymethylcellulose, and fluorescent whitening agent Tinopal CBS-X) was added to the beaker and agitated for 5 minutes. Sodium percarbonate and activator were added to the beaker, and the beaker contents agitated for one minute. A single EMPA 102 stain sheet (16 spots on cotton; Test Fabrics, Pittiston, Pa.) was added to the beaker, and the beaker contents agitated for 30 minutes. The wash water was then discarded, and the stain sheet rinsed twice (5 minutes each, with agitation) with fresh tap water (1 L) in the beaker. Water was squeezed gently out of each sheet by hand, and each sheet was then placed on a stationary horizontal rack in a dryer. The sheets were dried for 40 minutes on regular heat, after which time CIELAB lightness and color parameters (Final L*, Final a*, Final b*) were measured for the various spots on the stain sheet using a Datacolor Spectraflash SF650X spectrometer in reflectance mode, using a UV filter to remove wavelengths below 420 nm during optical property measurements. Final L* values closer to 100 and Final a* and Final b* values closer to zero indicate better cleaning. Tables 8 and 9 summarize the results.

TABLE 8

| | Optical | | Formulation | | | | | | | | |
|---|---|---|---|---|---|---|---|---|---|---|---|
| Evaluation | Property | Stain | A | B | C | D | E | F | G | H | I |
| 1 | Final L* | Makeup | 80 | 79 | 81 | 80 | 80 | 80 | 82 | 82 | 83 |
| 2 | Final L* | Curry | 86 | 88 | 86 | 86 | 86 | 87 | 85 | 92 | 85 |
| 3 | Final L* | Red Wine | 80 | 79 | 80 | 80 | 80 | 80 | 80 | 85 | 79 |
| 4 | Final L* | Empty | 96 | 96 | 96 | 96 | 96 | 96 | 96 | 97 | 96 |
| 5 | Final L* | Spaghetti Sauce | 94 | 94 | 94 | 94 | 95 | 95 | 94 | 95 | 93 |
| 6 | Final L* | Blood | 89 | 88 | 88 | 89 | 87 | 88 | 89 | 88 | 87 |
| 7 | Final L* | Dessert | 89 | 88 | 87 | 89 | 89 | 89 | 85 | 92 | 86 |
| 8 | Final L* | Peat | 92 | 92 | 92 | 92 | 92 | 93 | 91 | 92 | 91 |
| 9 | Final L* | Tea | 79 | 81 | 81 | 79 | 81 | 80 | 82 | 87 | 81 |
| 10 | Final L* | Beta-Carotene | 95 | 95 | 95 | 95 | 96 | 95 | 95 | 96 | 95 |
| 11 | Final L* | Grass | 94 | 94 | 94 | 94 | 94 | 94 | 94 | 95 | 94 |
| 12 | Final L* | Animal Fat & Dye | 74 | 71 | 71 | 74 | 75 | 73 | 73 | 77 | 70 |
| 13 | Final L* | Baby Food | 91 | 92 | 92 | 91 | 91 | 93 | 92 | 94 | 91 |
| 14 | Final L* | Clay | 91 | 91 | 92 | 91 | 91 | 92 | 90 | 92 | 91 |
| 15 | Final L* | Butter | 87 | 88 | 87 | 87 | 88 | 88 | 87 | 90 | 85 |
| 16 | Final L* | Engine Oil | 63 | 65 | 65 | 63 | 67 | 68 | 64 | 68 | 65 |
| 17 | Final a* | Makeup | 2.6 | 2.7 | 2.3 | 2.6 | 2.4 | 2.1 | 1.9 | 1.7 | 1.8 |
| 18 | Final a* | Curry | 4.3 | 3.6 | 4.5 | 4.3 | 4.2 | 4.6 | 5.4 | 1.3 | 5.5 |
| 19 | Final a* | Red Wine | 5.4 | 5.8 | 5.2 | 5.4 | 6.1 | 6.0 | 5.6 | 4.7 | 5.4 |
| 20 | Final a* | Empty | −0.5 | −0.8 | −0.4 | −0.5 | −0.8 | −0.8 | −0.7 | −1.2 | −0.5 |
| 21 | Final a* | Spaghetti Sauce | −0.2 | −0.6 | −0.2 | −0.2 | −0.6 | −0.7 | −0.3 | −0.9 | 0.0 |
| 22 | Final a* | Blood | 0.7 | 1.0 | 0.9 | 0.7 | 1.0 | 0.9 | 0.6 | 0.6 | 1.0 |
| 23 | Final a* | Dessert | 1.9 | 2.2 | 2.3 | 1.9 | 1.9 | 1.9 | 2.8 | 1.5 | 2.4 |
| 24 | Final a* | Peat | 0.9 | 0.7 | 0.7 | 0.9 | 0.7 | 0.4 | 0.7 | 0.6 | 0.9 |
| 25 | Final a* | Tea | 5.3 | 4.7 | 4.7 | 5.3 | 5.2 | 5.4 | 4.6 | 2.6 | 4.9 |
| 26 | Final a* | Beta-Carotene | −0.5 | −0.7 | −0.4 | −0.5 | −0.8 | −0.8 | −0.7 | −1.1 | −0.4 |
| 27 | Final a* | Grass | −0.5 | −0.7 | −0.4 | −0.5 | −0.7 | −0.7 | −0.9 | −1.2 | −0.6 |
| 28 | Final a* | Animal Fat & Dye | 24.3 | 25.7 | 27.3 | 24.3 | 22.6 | 25.3 | 26.2 | 20.8 | 26.3 |
| 29 | Final a* | Baby Food | 1.6 | 0.9 | 1.1 | 1.6 | 1.4 | 0.6 | 1.3 | −0.2 | 1.1 |
| 30 | Final a* | Clay | 1.2 | 1.1 | 1.1 | 1.2 | 1.4 | 0.9 | 1.6 | 0.8 | 1.3 |
| 31 | Final a* | Butter | 2.3 | 1.7 | 2.2 | 2.3 | 1.7 | 1.7 | 2.0 | 1.2 | 2.1 |
| 32 | Final a* | Engine Oil | 0.4 | 0.3 | 0.3 | 0.4 | 0.2 | 0.2 | 0.4 | 0.1 | 0.4 |
| 33 | Final b* | Makeup | 5.8 | 6.0 | 5.4 | 5.8 | 5.9 | 5.9 | 5.8 | 5.5 | 5.3 |
| 34 | Final b* | Curry | 15.8 | 14.2 | 16.6 | 15.8 | 16.5 | 17.5 | 17.8 | 14.1 | 18.2 |
| 35 | Final b* | Red Wine | 10.3 | 10.2 | 9.8 | 10.3 | 11.0 | 10.4 | 9.5 | 17.3 | 9.8 |
| 36 | Final b* | Empty | 4.3 | 4.9 | 4.4 | 4.3 | 5.0 | 5.2 | 4.7 | 5.0 | 4.3 |
| 37 | Final b* | Spaghetti Sauce | 6.6 | 8.1 | 7.5 | 6.6 | 6.6 | 7.0 | 7.6 | 7.3 | 7.4 |
| 38 | Final b* | Blood | 7.5 | 8.6 | 7.9 | 7.5 | 9.3 | 8.8 | 7.7 | 8.8 | 8.7 |
| 39 | Final b* | Dessert | 5.0 | 5.6 | 4.9 | 5.0 | 5.7 | 5.7 | 5.8 | 6.8 | 4.9 |
| 40 | Final b* | Peat | 6.1 | 6.5 | 5.6 | 6.1 | 6.7 | 6.6 | 6.5 | 7.4 | 6.2 |
| 41 | Final b* | Tea | 16.1 | 15.1 | 14.8 | 16.1 | 16.1 | 17.0 | 14.7 | 18.2 | 15.2 |
| 42 | Final b* | Beta-Carotene | 7.3 | 7.8 | 6.2 | 7.3 | 6.4 | 7.8 | 7.1 | 6.0 | 7.8 |
| 43 | Final b* | Grass | 7.1 | 7.9 | 7.2 | 7.1 | 8.1 | 7.8 | 7.8 | 7.7 | 7.2 |
| 44 | Final b* | Animal Fat & Dye | 7.5 | 6.7 | 7.1 | 7.5 | 5.9 | 6.5 | 6.6 | 6.5 | 6.7 |
| 45 | Final b* | Baby Food | 8.6 | 7.9 | 7.5 | 8.6 | 8.5 | 7.8 | 8.2 | 9.4 | 8.1 |
| 46 | Final b* | Clay | 10.0 | 9.9 | 8.8 | 10.0 | 10.4 | 9.8 | 11.3 | 10.4 | 9.8 |
| 47 | Final b* | Butter | 9.6 | 9.2 | 9.3 | 9.6 | 9.0 | 9.2 | 9.3 | 8.9 | 8.7 |
| 48 | Final b* | Engine Oil | 3.5 | 3.8 | 4.2 | 3.5 | 4.2 | 4.0 | 3.9 | 4.0 | 3.8 |

TABLE 9

| | Optical | | Formulation | | | | | | | | |
|---|---|---|---|---|---|---|---|---|---|---|---|
| Evaluation | Property | Stain | J | K | L | M | N | O | P | Q | R |
| 49 | Final L* | Makeup | 81 | 81 | 80 | 80 | 79 | 77 | 80 | 79 | 81 |
| 50 | Final L* | Curry | 86 | 86 | 86 | 85 | 87 | 87 | 87 | 91 | 86 |
| 51 | Final L* | Red Wine | 78 | 79 | 80 | 80 | 80 | 79 | 80 | 84 | 79 |
| 52 | Final L* | Empty | 96 | 96 | 96 | 96 | 96 | 96 | 96 | 97 | 96 |
| 53 | Final L* | Spaghetti Sauce | 93 | 94 | 95 | 95 | 94 | 95 | 95 | 94 | 9 |
| 54 | Final L* | Blood | 88 | 88 | 86 | 87 | 87 | 90 | 88 | 87 | 88 |
| 55 | Final L* | Dessert | 88 | 87 | 86 | 87 | 86 | 88 | 88 | 91 | 87 |
| 56 | Final L* | Peat | 91 | 91 | 92 | 92 | 92 | 93 | 92 | 93 | 92 |
| 57 | Final L* | Tea | 81 | 80 | 81 | 80 | 81 | 84 | 82 | 87 | 80 |
| 58 | Final L* | Beta-Carotene | 95 | 95 | 95 | 95 | 95 | 95 | 95 | 96 | 95 |
| 59 | Final L* | Grass | 94 | 93 | 94 | 94 | 94 | 94 | 94 | 95 | 94 |
| 60 | Final L* | Animal Fat & Dye | 73 | 75 | 73 | 78 | 74 | 76 | 76 | 76 | 74 |
| 61 | Final L* | Baby Food | 92 | 92 | 92 | 91 | 93 | 93 | 93 | 94 | 92 |
| 62 | Final L* | Clay | 90 | 92 | 91 | 91 | 91 | 92 | 92 | 91 | 90 |
| 63 | Final L* | Butter | 88 | 88 | 87 | 88 | 88 | 89 | 89 | 89 | 87 |
| 64 | Final L* | Engine Oil | 66 | 67 | 69 | 72 | 68 | 66 | 70 | 65 | 64 |
| 65 | Final a* | Makeup | 2.2 | 2.1 | 2.5 | 2.5 | 2.6 | 2.8 | 2.3 | 2.2 | 2.3 |
| 66 | Final a* | Curry | 4.7 | 5.0 | 4.3 | 5.0 | 4.0 | 4.8 | 4.4 | 2.3 | 4.3 |
| 67 | Final a* | Red Wine | 5.8 | 6.0 | 5.5 | 5.7 | 6.2 | 6.1 | 5.5 | 5.2 | 5.6 |
| 68 | Final a* | Empty | −0.5 | −0.6 | −0.4 | −0.7 | −0.7 | −0.8 | −0.8 | −1.0 | −0.5 |
| 69 | Final a* | Spaghetti Sauce | −0.2 | −0.4 | −0.1 | −0.5 | −0.4 | −0.6 | −0.5 | −0.3 | −0.1 |
| 70 | Final a* | Blood | 0.8 | 0.8 | 1.3 | 1.2 | 1.1 | 0.5 | 0.9 | 0.9 | 0.9 |
| 71 | Final a* | Dessert | 2.0 | 2.5 | 2.5 | 2.3 | 2.8 | 2.2 | 2.3 | 1.9 | 2.4 |
| 72 | Final a* | Peat | 0.9 | 0.7 | 0.8 | 0.6 | 1.1 | 0.4 | 0.7 | 0.3 | 0.7 |
| 73 | Final a* | Tea | 4.9 | 5.4 | 5.2 | 5.4 | 5.3 | 3.8 | 4.8 | 2.5 | 5.0 |
| 74 | Final a* | Beta-Carotene | −0.5 | −0.5 | −0.2 | −0.4 | −0.7 | −0.5 | −0.6 | −0.9 | −0.4 |
| 75 | Final a* | Grass | −0.4 | −0.7 | −0.3 | −0.4 | −0.7 | −0.8 | −0.8 | −1.1 | −0.6 |
| 76 | Final a* | Animal Fat & Dye | 26.0 | 24.4 | 27.7 | 22.0 | 26.6 | 24.1 | 24.6 | 23.6 | 24.8 |
| 77 | Final a* | Baby Food | 1.2 | 1.1 | 1.2 | 1.2 | 0.9 | 0.8 | 0.8 | −0.1 | 1.0 |
| 78 | Final a* | Clay | 1.5 | 1.0 | 1.4 | 1.5 | 1.4 | 1.1 | 1.1 | 1.2 | 1.6 |
| 79 | Final a* | Butter | 1.7 | 1.7 | 1.9 | 1.7 | 2.3 | 1.6 | 1.5 | 1.7 | 2.2 |
| 80 | Final a* | Engine Oil | 0.2 | 0.2 | 0.2 | 0.0 | 0.1 | 0.3 | 0.1 | 0.2 | 0.3 |
| 81 | Final b* | Makeup | 5.1 | 5.7 | 5.4 | 6.0 | 5.9 | 6.0 | 5.6 | 5.7 | 5.2 |
| 82 | Final b* | Curry | 16.4 | 17.3 | 17.3 | 18.7 | 15.5 | 17.5 | 17.2 | 17.0 | 15.8 |
| 83 | Final b* | Red Wine | 10.9 | 10.2 | 10.6 | 10.4 | 11.3 | 10.6 | 9.8 | 18.3 | 10.5 |
| 84 | Final b* | Empty | 4.3 | 5.1 | 4.6 | 5.5 | 5.0 | 5.2 | 4.8 | 4.8 | 4.4 |
| 85 | Final b* | Spaghetti Sauce | 7.1 | 7.8 | 7.6 | 7.6 | 7.2 | 7.5 | 7.6 | 7.8 | 7.6 |
| 86 | Final b* | Blood | 8.2 | 8.7 | 9.5 | 9.7 | 9.1 | 8.1 | 9.1 | 9.3 | 8.8 |
| 87 | Final b* | Dessert | 5.1 | 5.6 | 5.1 | 6.0 | 6.0 | 5.9 | 5.6 | 7.0 | 5.4 |
| 88 | Final b* | Peat | 6.2 | 6.6 | 6.1 | 6.9 | 6.9 | 6.4 | 6.4 | 6.7 | 6.2 |
| 89 | Final b* | Tea | 15.2 | 16.3 | 15.7 | 16.8 | 17.1 | 13.6 | 15.1 | 17.4 | 15.5 |
| 90 | Final b* | Beta-Carotene | 6.7 | 9.3 | 7.8 | 8.0 | 6.9 | 7.3 | 6.7 | 7.1 | 7.6 |
| 91 | Final b* | Grass | 7.1 | 8.0 | 6.6 | 8.4 | 7.9 | 7.8 | 7.8 | 7.9 | 7.1 |
| 92 | Final b* | Animal Fat & Dye | 6.7 | 6.2 | 6.8 | 6.0 | 7.6 | 6.2 | 6.1 | 6.0 | 6.9 |
| 93 | Final b* | Baby Food | 7.7 | 8.2 | 7.4 | 8.7 | 7.9 | 7.8 | 7.7 | 9.0 | 7.5 |
| 94 | Final b* | Clay | 10.7 | 9.7 | 9.4 | 10.8 | 10.8 | 9.8 | 9.7 | 10.9 | 11.1 |
| 95 | Final b* | Butter | 8.6 | 9.2 | 9.0 | 9.5 | 9.7 | 8.7 | 8.9 | 9.4 | 9.1 |
| 96 | Final b* | Engine Oil | 4.1 | 4.3 | 4.3 | 4.7 | 4.1 | 3.9 | 4.7 | 4.7 | 3.7 |

The data in tables 8 and 9 show that formulations containing the inventive M-carbene activators often provide equivalent or better performance (Final L* closer to 100 and/or Final a* or Final b* closer to zero) than do analogous formulations containing comparative Mn-based activators (A350 and Tinocat® TRS KB2) or the organic activator TAED.

Tables 10 and 11 summarize the overall performance of the formulations containing the inventive M-carbene activators, tabulating the number of spots (out of a possible 16 on the EMPA 102 stain sheet) in which formulations of the M-carbene activators provided stains with equivalent or improved post-washing lightness (L*) or color (a* or b*) relative to those obtained from analogous formulations containing Mn-based activators (A350 and Tinocat® TRS KB2) or the organic activator TAED under otherwise equivalent conditions.

TABLE 10

| Reference | Optical | M-Carbene-Containing Formulation | | | | | |
|---|---|---|---|---|---|---|---|
| Formulation | Property | A | B | C | D | E | F |
| G | Final L* | 12 | 11 | 12 | 13 | 12 | 13 |
| G | Final a* | 10 | 10 | 11 | 10 | 8 | 9 |
| G | Final b* | 10 | 7 | 11 | 6 | 7 | 8 |
| H | Final L* | 2 | 2 | 3 | 3 | 3 | 5 |
| H | Final a* | 4 | 4 | 4 | 5 | 4 | 5 |
| H | Final b* | 11 | 9 | 10 | 7 | 9 | 10 |
| I | Final L* | 13 | 15 | 15 | 13 | 15 | 14 |
| I | Final a* | 10 | 10 | 12 | 7 | 7 | 9 |
| I | Final b* | 8 | 7 | 10 | 4 | 4 | 6 |

TABLE 11

| Reference | Optical | M-Carbene-Containing Formulation | | | | | |
|---|---|---|---|---|---|---|---|
| Formulation | Property | J | K | L | M | N | O |
| P | Final L* | 6 | 5 | 7 | 9 | 7 | 13 |
| P | Final a* | 7 | 9 | 6 | 8 | 5 | 10 |
| P | Final b* | 12 | 4 | 9 | 3 | 4 | 7 |
| Q | Final L* | 3 | 5 | 4 | 6 | 5 | 7 |
| Q | Final a* | 8 | 8 | 5 | 6 | 4 | 6 |
| Q | Final b* | 15 | 11 | 12 | 8 | 11 | 11 |
| R | Final L* | 13 | 14 | 12 | 12 | 13 | 15 |
| R | Final a* | 9 | 7 | 9 | 8 | 4 | 9 |
| R | Final b* | 12 | 4 | 8 | 4 | 4 | 7 |

The data in tables 10 and 11 show that formulations containing the inventive M-carbene activators often provide equivalent or better performance (Final L* closer to 100 and/or Final a* or Final b* closer to zero) on multiple stains than do analogous formulations containing comparative Mn-based activators A350 and Tinocat® TRS KB2 or the organic activator TAED.

While the present invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

What is claimed is:

1. A cleaning composition comprising a peroxy compound and one or more activators present in an effective amount to activate the peroxy compound, said activators present in an effective amount to accomplish bleaching or cleaning or oxidation, the activators comprising one or more metallocarbenes of the general structure: 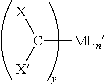
where M represents a metal selected from the group consisting of Fe, Os, Mn, Re, Cu, Ag, Au, Co, Cr, Mo, W, Ru, Sc, Y, La, Ti, Zr, Hf, V, Nb, Ta, Ni, Pd, Pt, and Zn, C represents the carbene carbon bound to the metal center, X and X′ may be the same or different and selected from the group consisting of C, N, O, Si, P, and S, each of which may be substituted with hydrogen and or C1-C20 linear or branched hydrocarbons which may contain heteroatom substituents and which may form or be part of a cyclic structure, Lₙ′ represents one or more ligands which may or may not include one or more metal centers, and where y≧1.

2. The cleaning composition of claim 1 wherein M represents a metal selected from the group consisting of Fe, Mn, Cu, Co, Mo, W, V and Ti.

3. The cleaning composition of claim 1 wherein M represents a metal selected from the group consisting of Fe, Mn and Cu.

4. The cleaning compositions of claim 1 further comprising activators selected from the group consisting of organic activators, metal catalysts and mixtures thereof.

5. The cleaning composition of claim 4 wherein said organic activator is selected from the group consisting of N,N,N′,N′-tetraacetylethylenediamine, nonanoyloxybenzenesulfonate sodium, lauroyloxybenzene sulfonate, benzyloxybenzene sulfonate, iminium-containing species, acetonitrile derivatives and mixtures thereof.

6. The cleaning composition of claim 5 wherein said iminium-containing species is selected from the group consisting of sulphuric acid mono-[2-(3,4-dihydro-isoquinolin-2-yl)-1-(2-butyl-octyloxymethyl)-ethyl]ester and sulphuric acid mono-[2-(3,4-dihydro-isoquinolin-2-yl)-1-(2-ethylhexyloxymethyl)-ethyl]ester and mixtures thereof.

7. The cleaning composition of claim 5 wherein said acetonitrile derivative is selected from the group consisting of N-methylmorpholinium acetonitrile methylsulfate, N-methlymorpholinium acetonitrile hydrogensulfate and mixtures thereof.

8. The cleaning composition of claim 4 wherein said metal catalysts are selected from the group consisting of tri-mu-oxo-bis[(1,4,7-trimethyl-1,4,7-triazacyclononane)manganese]bis(acetate), tri-mu-oxo-bis[(1,4,7-trimethyl-1,4,7-triazacyclononane)manganese]bis(hexafluorophosphate), [5,12-diethyl-1,5,8,12,-tetraaza-bicyclo[6.6.2]hexadecane]manganese dichloride and mixtures thereof.

9. The cleaning formulation of claim 1 wherein said peroxy compound is selected from the group consisting of hydrogen peroxide, inorganic perhydrate salts, atmospheric oxygen, organic peroxides, organic perhydroxides, peracids and mixtures thereof.

10. The cleaning composition of claim 9 wherein said perhydrate salts are selected from the group consisting of perborate, percarbonate, persulfate, perphosphate, and persilicate salts.

11. The cleaning composition of claim 1 further comprising additives selected from the group consisting of bleaching agents, activators, surfactants, humectants, enzymes, thickeners, dispersants, fluorescent dyes, coupling agents, polar organic solvents, builders, abrasives, chelating agents, acids, fragrances, colorants, dyes, enzyme stabilizing agents, bleach boosters, brighteners, organic polymers, dye transfer inhibiting agents, chelating agents, catalyst/activator/booster carriers, preformed peracids, hydrotropes, antimicrobial agents, antibacterial agents, perfumes, suds suppressors, anti-corrosion agents, tarnish inhibitors, fabric softeners, carriers, processing aids, solvents, pigments, water, and mixtures thereof.

12. The cleaning composition of claim 1 wherein the composition is in a physical form selected from the group consisting of a tablet, a granular solid, a powder solid, a liquid, a gel, a paste, an emulsion or suspension and supported or adsorbed on woven or non-woven fibers, and combinations thereof.

13. A method of catalyzing a bleaching compound in a cleaning composition comprising adding to a bleaching compound a bleaching compound activator comprising one or more metallocarbenes of the general structure: 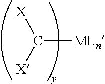
where M represents a metal selected from the group consisting of Fe, Os, Mn, Re, Cu, Ag, Au, Co, Cr, Mo, W, Ru, Sc, Y, La, Ti, Zr, Hf, V, Nb, Ta, Ni, Pd, Pt, and Zn, C represents the carbene carbon bound to the metal center, X and X′ may be the same or different and selected from the group C, N, O, Si, P, or S, each of which may be substituted with hydrogen and or C1-C20 linear or branched hydrocarbons which may contain heteroatom substituents and which may form or be part of a cyclic structure, Lₙ′ represents one or more ligands which may or may not include one or more metal centers, and where y≧1.

14. The method of claim 13 wherein M represents a metal selected from the group consisting of Fe, Mn, Cu, Co, Mo, W, V and Ti.

15. The method of claim 13 wherein M represents a metal selected from the group consisting of Fe, Mn and Cu.

16. The method of claim 13 further comprising adding beaching activators selected from the group consisting of organic activators, metal catalysts and mixtures thereof.

17. The method of claim 13 wherein said organic activators is selected from the group consisting of N,N,N′,N′-tetraacetylethylenediamine, nonanoyloxybenzenesulfonate sodium, lauroyloxybenzene sulfonate, benzyloxybenzene sulfonate, iminium-containing species, acetonitrile derivatives and mixtures thereof.

18. The method of claim 13 wherein said iminium-containing species is selected from the group consisting of sulphuric acid mono-[2-(3,4-dihydro-isoquinolin-2-yl)-1-(2-butyl-octyloxymethyl)-ethyl]ester and sulphuric acid mono-[2-(3,4-dihydro-isoquinolin-2-yl)-1-(2-ethylhexyloxymethyl)-ethyl]ester and mixtures thereof.

19. The method of claim 13 wherein said acetonitrile derivative is selected from the group consisting of N-methylmorpholinium acetonitrile methylsulfate, N-methlymorpholinium acetonitrile hydrogensulfate and mixtures thereof.

20. The method of claim 13 wherein said metal catalysts are selected from the group consisting of tri-mu-oxo-bis[(1,4,7-trimethyl-1,4,7-triazacyclononane)manganese]bis(acetate), tri-mu-oxo-bis[(1,4,7-trimethyl-1,4,7-triazacyclononane)manganese]bis(hexafluorophosphate), [5,12-diethyl-1,5,8,12,-tetraaza-bicyclo[6.6.2]hexadecane]manganese dichloride, and mixtures thereof.

21. The method of claim 13 further comprising adding cleaning composition components selected from the group consisting of bleaching agents, activators, surfactants, humectants, enzymes, thickeners, dispersants, fluorescent dyes, coupling agents, polar organic solvents, builders, abrasives, chelating agents, acids, fragrances, colorants, dyes, enzyme stabilizing agents, bleach boosters, brighteners, organic polymers, dye transfer inhibiting agents, chelating agents, catalyst/activator/booster carriers, preformed peracids, hydrotropes, antimicrobial agents, antibacterial agents, perfumes, suds suppressors, anti-corrosion agents, tarnish inhibitors, fabric softeners, carriers, processing aids, solvents, pigments, water, and mixtures thereof.

22. The method of claim 13 wherein the composition is in a physical form selected from the group consisting of a tablet, a granular solid, a powder solid, a liquid, a gel, a paste, an emulsion or suspension and supported or adsorbed on woven or non-woven fibers, and combinations thereof.
